(19) United States
(12) Patent Application Publication
(10) Pub. No.: US 2023/0137192 A1
(43) Pub. Date: May 4, 2023

(54) DETECTION METHOD OF LIDAR, LIDAR, AND SYSTEM FOR VEHICLE INCLUDING THE SAME

(71) Applicant: Hesai Technology Co., Ltd., Shanghai (CN)

(72) Inventors: Feng LIANG, Shanghai (CN); Xiaotong ZHOU, Shanghai (CN); Shaoqing XIANG, Shanghai (CN)

(21) Appl. No.: 18/091,887

(22) Filed: Dec. 30, 2022

Related U.S. Application Data
(63) Continuation of application No. PCT/CN2021/106692, filed on Jul. 16, 2021.

(30) Foreign Application Priority Data
Aug. 21, 2020 (CN) 202010851537.4

(51) Int. Cl. G01S 17/894; G01S 17/931; G01S 17/86

(52) U.S. Cl. CPC G01S 17/894; G01S 17/931; G01S 17/86

(57) ABSTRACT

A detection method (100) of a lidar (200), the lidar (200), and a system for a vehicle (300) including the same. The lidar (200) is capable of rotating around a rotating shaft, and includes an emitting unit (210) having a plurality of laser emitters (211). The detection method (100) includes: step S101, controlling the plurality of laser emitters (211) to emit laser beams for detection so that the lidar (200) has a non-uniform angular resolution along a horizontal direction; step S102, receiving echoes of the emitted laser beams for detection reflected by a target object and converting the echoes into electrical signals; and step S103, calculating a distance and/or reflectivity of the target object according to the electrical signals. Thereby, an angular resolution along a horizontal direction of the lidar (200) is flexibly configured, flight time and power consumption are reduced, and a detection range of the lidar (200) is improved.

### CROSS-REFERENCE TO RELATED APPLICATIONS

This patent application is a continuation of International Application No. PCT/CN2021/106692, filed on Jul. 16, 2021. This patent application claims foreign priority to Chinese Patent Application No. 202010851537.4, filed on Aug. 21, 2020. Herein which is incorporated by reference.

### TECHNICAL FIELD

The present disclosure generally relates to the field of lidar technology, and in particular, to a detection method of a lidar, a lidar, and a system for a vehicle including the lidar.

### BACKGROUND OF THE INVENTION

FIG. 1 shows an identification form of a coordinate system of a lidar. Referring to FIG. 1, Z direction represents a direction consistent with a rotating shaft, and is also referred to as a vertical direction. An angular interval between lines in the vertical direction is referred to as a vertical resolution. XOY plane is a horizontal plane, and a resolution on the horizontal plane is referred to as a horizontal resolution. An existing multi-line (for example, 40/64/128-line) mechanical lidar is capable of setting an angular resolution along a vertical direction of adjacent lines by adjusting relative arrangement of light sources. Referring to FIG. 1, FIG. 2A, and FIG. 2B, an existing mechanical lidar generally has two arrangement manners of laser emitters and corresponds to two emitting manners of light beams. The two arrangement manners are respectively as follows: multiple lines of a mechanical lidar as shown in FIG. 2A are evenly distributed in a vertical field of view, that is, the angular resolution along a vertical direction of adjacent lines is the same; an included angle of adjacent lines of a mechanical lidar as shown in FIG. 2B is not the same, specifically, angular resolution along a vertical direction of lines in the middle is more intensive than that of lines on two sides. It should be noted that, FIG. 1, FIG. 2A, and FIG. 2B only select one column of laser emitters as a schematic diagram, and specifically, more than one column of laser emitters may be set.

In the prior art, a rotation frequency of the mechanical lidar is generally 10 Hz or 20 Hz. Referring to FIG. 3A, a mechanical lidar with the rotation frequency of 10 Hz basically emits and receives all lines at intervals of 0.2° in a horizontal plane, for example, a 16-line lidar scans at this frequency to obtain a point cloud map as shown in FIG. 3B. Referring to FIG. 4A, a mechanical lidar with the rotation frequency of 20 Hz basically emits and receives all lines at intervals of 0.4° in a horizontal plane, for example, a 16-line lidar scans at this frequency to obtain a point cloud map as shown in FIG. 4B. As described above, a sequence of multi-line reception and emission may be operated either in turn (such as one line at a time, or some of multiple lines at a time, but not all of multiple lines being emitted or received at a same time), or at a same time. It should be noted that, FIG. 3A, FIG. 3B, FIG. 4A, and FIG. 4B are only schematic diagrams. During light reception and emission, the mechanical lidar rotates continuously rather than stops. Because a speed of the light is much faster than a speed of the mechanical lidar itself, FIG. 3A, FIG. 3B, FIG. 4A, and FIG. 4B ignore the rotation of the mechanical lidar and only schematically show angle intervals of multiple times of light reception and emission. In addition, FIG. 3A, FIG. 3B, FIG. 4A, and FIG. 4B only schematically show a frequency (the number of occurrences of a repeating event per unit time) of light reception and emission for ranging, and does not show a real frequency of light reception and emission.

The content of “Background” is merely technologies known to the inventor, and does not represent prior art in the field.

### BRIEF SUMMARY OF THE INVENTION

In embodiments of the present disclosure, a plurality of laser emitters are controlled to emit light in different horizontal fields of view. Flexible adjustment of an angular resolution along a horizontal direction of a lidar is realized, power consumption of the lidar is reduced, furthermore a detection range of the lidar is improved.

In view of at least one defect in the prior art, the present disclosure provides a detection method of a lidar, the lidar capable of rotating around a rotating shaft at a constant speed and including an emitting unit having a plurality of laser emitters, the detection method including:

S101: controlling the plurality of laser emitters to emit laser beams for detection so that the lidar has a non-uniform angular resolution along a horizontal direction;

S102: receiving echoes of the emitted laser beams reflected by a target object and converting the echoes into electrical signals; and

S103: calculating a distance and/or reflectivity of the target object according to the electrical signals.

According to an aspect of the present disclosure, the step S101 includes:
controlling the plurality of laser emitters to emit the laser beams for detection at frequencies relatively different from each other; and/or
controlling the plurality of laser emitters to emit the laser beams for detection at frequencies relatively different in different horizontal fields of view; and/or
controlling the plurality of laser emitters and selecting at least partially different laser emitters to emit the laser beams for detection at different horizontal angles.

According to an aspect of the present disclosure, the plurality of laser emitters are arranged in one or more columns along the direction of the rotating shaft, and the step S101 includes: controlling, in at least a subsection of the horizontal fields of view, laser emitters located adjacent to a central part of vertical fields of view in the one or more columns to emit the laser beams for detection at a frequency higher than that of laser emitters located adjacent to a peripheral part of the vertical fields of view.

According to an aspect of the present disclosure, the step S101 includes: controlling the plurality of laser emitters to emit the laser beams for detection in a predetermined field of view that is located in front of a vehicle and along a travel direction of the vehicle at a higher frequency than that outside the predetermined field of view, wherein the vehicle is equipped with the lidar.

According to an aspect of the present disclosure, the plurality of laser emitters are arranged in one or more columns along the direction of the rotating shaft, and the detection method further includes:
receiving scene information,
where the step S101 further includes: determining an expected angular resolution along a horizontal direction for a lidar point cloud according to the scene information and adjusting light emission frequency of the laser emitter.

According to an aspect of the present disclosure, the step S101 includes: when it is detected or received that the vehicle equipped with the lidar is in a downhill state, controlling laser emitters located adjacent to a lower side in at least one column of laser emitters to emit the laser beams for detection at a higher frequency than that of laser emitters located adjacent to an upper side.

According to an aspect of the present disclosure, the step S101 includes: when it is detected or received that the vehicle equipped with the lidar is in an uphill state, controlling laser emitters located adjacent to an upper side in at least one column of laser emitters to emit the laser beams for detection at a higher frequency than that of laser emitters located adjacent to a lower side.

According to an aspect of the present disclosure, the step S101 includes: when a preset obstacle is detected, depending on the type and location of the obstacle, controlling the laser emitter to emit the laser beams for a next detection at a frequency different from that of a previous detection of the obstacle.

According to an aspect of the present disclosure, the step S101 includes: when a pedestrian or a traffic cone is detected, controlling the laser emitter to emit the laser beams at a higher frequency for the next detection of the obstacle.

According to an aspect of the present disclosure, the step S101 includes: when a tree is detected, controlling the laser emitter to emit the laser beams for detection at a lower frequency for a next detection of the obstacle.

The present disclosure further provides a lidar, the lidar capable of rotating around a rotating shaft at a constant speed, and including:
an emitting unit, including a plurality of laser emitters, the plurality of laser emitters being configured to emit laser beams for detecting a target object;
a receiving unit, configured to receive echoes of the emitted laser beams for detection reflected by the target object and convert the echoes into electrical signals; and
a control unit, coupled to the emitting unit, and configured to control the plurality of laser emitters to emit the laser beams for detection so that the lidar has a non-uniform angular resolution along a horizontal direction.

According to an aspect of the present disclosure, the control unit is configured to: control the plurality of laser emitters to emit the laser beams for detection at frequencies relatively different from each other; and/or
control the plurality of laser emitters to emit the laser beams for detection at frequencies relatively different in different horizontal fields of view; and/or
control the plurality of laser emitters and select at least partially different laser emitters to emit the laser beams for detection at different horizontal angles.

According to an aspect of the present disclosure, the plurality of laser emitters are arranged in one or more columns along the direction of the rotating shaft, and the control unit is configured to: control, in at least a subsection of the horizontal fields of view, laser emitters located adjacent to a central part of vertical fields of view in the one or more columns to emit the laser beams for detection at a frequency higher than that of laser emitters located adjacent to a peripheral part of the vertical fields of view.

According to an aspect of the present disclosure, the control unit is configured to: control the plurality of laser emitters to emit the laser beams for detection in a predetermined field of view that is located in front of a vehicle and along a travel direction of the vehicle at a higher frequency than that outside the predetermined field of view, wherein the vehicle is equipped with the lidar.

According to an aspect of the present disclosure, the plurality of laser emitters are arranged in one or more columns along the direction of the rotating shaft, and the control unit is configured to determine an expected angular resolution along a horizontal direction for a lidar point cloud according to received scene information and adjust light emission frequency of the laser emitter.

According to an aspect of the present disclosure, the control unit is adapted to: when a preset obstacle is detected, depending on the type and location of the obstacle, control the laser emitter to emit the laser beams for a next detection at a frequency different from that of a previous detection of the obstacle.

According to an aspect of the present disclosure, the control unit is adapted to: when a pedestrian or a traffic cone is detected, control the laser emitter to emit the laser beams at a higher frequency for the next detection of the obstacle.

According to an aspect of the present disclosure, the control unit is adapted to: when a tree is detected, control the laser emitter to emit the detection laser beams at a lower frequency for a next detection of the obstacle.

The present disclosure further provides a system for a vehicle, including:
a vehicle body; and
the lidar according to any one of the foregoing aspects, the lidar being installed on the vehicle body, so as to detect a target object around the vehicle body.

According to an aspect of the present disclosure, the lidar is installed at the front of the vehicle body, and a control unit of the lidar is configured to: control the plurality of laser emitters to emit the laser beams for detection in a predetermined field of view that is located in front of a vehicle and along a travel direction of the vehicle at a higher frequency than that outside the predetermined field of view, wherein the vehicle is equipped with the lidar.

According to an aspect of the present disclosure, the lidar is installed on a roof of the vehicle body, the plurality of laser emitters are arranged in one or more columns along the direction of the rotating shaft, the system further includes a photographing unit, the photographing unit is capable of collecting collect images around the vehicle and determine scene information according to the images, and the control unit of the lidar communicates with the photographing unit to receive the scene information and is configured to determine an expected angular resolution along a horizontal direction for a lidar point cloud according to the scene information and adjust light emission frequency of the laser emitter.

Embodiments of the present disclosure adjust light emission frequency of emitters in different lines according to different application scenarios to realize a flexible configuration of the angular resolution along a horizontal direction of the lidar, maximize the use of limited flight time and power consumption, and improve the detection range of the lidar.

### BRIEF DESCRIPTION OF THE SEVERAL VIEWS OF THE DRAWING(S)

The accompanying drawings are used for providing a further understanding of the present disclosure, and constitute a part of the specification. The accompanying drawings are used for explaining this application in combination with embodiments of the present disclosure, but do not constitute a limitation to the present disclosure. In the accompanying drawings:

FIG. 1 shows an identification form of a coordinate system of a lidar;

FIG. 2A shows a schematic diagram of a uniform arrangement of laser emitters in an existing mechanical lidar;

FIG. 2B shows a schematic diagram of anon-uniform arrangement of laser emitters in an existing mechanical lidar;

FIG. 3A shows a schematic diagram of horizontal angular intervals of a mechanical lidar with a rotation frequency of 10 Hz;

FIG. 3B shows a partial schematic diagram of a point cloud map of a lidar obtained by scanning according to FIG. 3A;

FIG. 4A shows a schematic diagram of horizontal angular intervals of a mechanical lidar with a rotation frequency of 20 Hz;

FIG. 4B shows a partial schematic diagram of a point cloud map of a lidar obtained by scanning according to FIG. 4A;

FIG. 5 shows a flowchart of a detection method of a lidar according to an embodiment of the present disclosure;

FIG. 6 shows a schematic diagram of light reception and emission for ranging of a lidar within a horizontal angle range according to an embodiment of the present disclosure;

FIG. 7 shows a schematic diagram of a lidar point cloud according to an embodiment of the present disclosure;

FIG. 8A and FIG. 8B show partial schematic diagrams of a lidar point cloud according to an embodiment of the present disclosure;

FIG. 9A and FIG. 9B show partial schematic diagrams of a lidar point cloud according to an embodiment of the present disclosure;

FIG. 10A and FIG. 10B show partial schematic diagrams of a lidar point cloud according to an embodiment of the present disclosure;

FIG. 11A and FIG. 11B show partial schematic diagrams of a lidar point cloud according to an embodiment of the present disclosure;

FIG. 12 shows a schematic diagram of a lidar installed on a roof of a vehicle according to an embodiment of the present disclosure;

FIG. 13A and FIG. 13B show schematic diagrams of arrangement of laser emitters according to an embodiment of the present disclosure;

FIG. 14 shows a partial schematic diagram of scanning a point cloud according to an embodiment of the present disclosure;

FIG. 15A shows a side view of a lidar installed at the front of a vehicle according to an embodiment of the present disclosure, and FIG. 15B shows a front view of a lidar installed at the front of a vehicle according to an embodiment of the present disclosure;

FIG. 16A shows a schematic diagram of light reception and emission for ranging of the lidars shown in FIG. 15A and FIG. 15B within a horizontal angle range;

FIG. 16B shows a schematic diagram of a lidar point cloud according to an embodiment of the present disclosure;

FIG. 17 shows a schematic diagram of a vehicle equipped with a lidar in a downhill state according to an embodiment of the present disclosure;

FIG. 18A and FIG. 18B show schematic diagrams of arrangement of laser emitters of the lidar shown in FIG. 17;

FIG. 18C shows a partial schematic diagram of a lidar point cloud according to an embodiment of the present disclosure;

FIG. 19 shows a schematic diagram of a vehicle equipped with a lidar in an uphill state according to an embodiment of the present disclosure;

FIG. 20A and FIG. 20B show schematic diagrams of arrangement of laser emitters of the lidar shown in FIG. 19;

FIG. 20C shows a partial schematic diagram of a lidar point cloud according to an embodiment of the present disclosure;

FIG. 21 shows a schematic diagram of detection by a lidar according to an embodiment of the present disclosure;

FIG. 22 shows a schematic diagram of detection by a lidar when a traffic cone is detected according to an embodiment of the present disclosure;

FIG. 23 shows a schematic diagram of detection by a lidar when a pedestrian is detected according to an embodiment of the present disclosure;

FIG. 24 shows a schematic diagram of detection by a lidar when a tree is detected according to an embodiment of the present disclosure;

FIG. 25 is a block diagram of a lidar according to an embodiment of the present disclosure; and

FIG. 26 is a schematic diagram of a system for a vehicle according to an embodiment of the present disclosure.

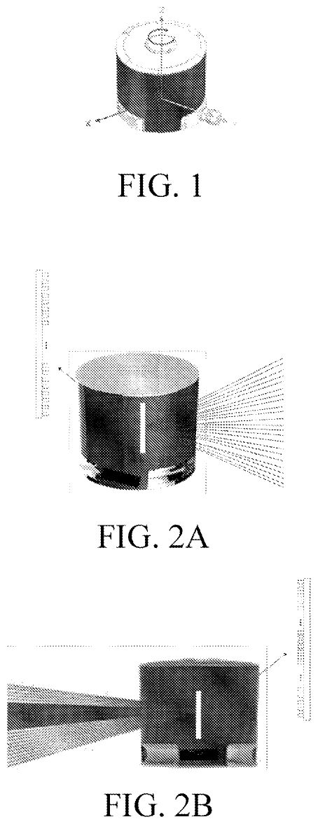

### DETAILED DESCRIPTION OF THE INVENTION

In order to enable those skilled in the art to better understand and implement the present disclosure, each embodiment of the present application will be described in detail below. Only certain exemplary embodiments are briefly described below. As those skilled in the art can realize, the described embodiments may be modified in various different ways without departing from the spirit or the scope of the present disclosure. Therefore, the accompanying drawings and the description are to be considered exemplary in nature but not restrictive.

In the description of the present disclosure, it should be understood that directions or position relationships indicated by terms “center”, “longitudinal”, “landscape”, “length”, “width”, “thickness”, “upper”, “lower”, “front”, “rear”, “left”, “right”, “vertical”, “horizontal”, “top”, “bottom”, “inner”, “outer”, “clockwise”, and “counterclockwise” are directions or position relationships shown based on the accompanying drawings, are merely used for the convenience of describing the present disclosure and simplifying the description, but are not used to indicate or imply that a device or an element must have a particular direction or must be constructed and operated in a particular direction, and therefore, cannot be understood as a limitation to the present disclosure. In addition, the terms “first” and “second” are used for describing purposes only and are not to be construed as indicating or implying relative importance or implicitly indicating a quantity of technical features indicated. Thus, features defined by “first” and “second” may explicitly or implicitly include one or more of the features. In the description of the present disclosure, unless otherwise explicitly specified, “a plurality of” means two or more than two.

In the description of the present disclosure, it should be noted that, unless otherwise explicitly specified or defined, the terms such as “installation”, “couple”, and “connect” should be understood in a broad sense. For example, the connection may be a fixed connection, a detachable connection, or an integral connection; may be a mechanical connection, an electrical connection, or mutual communication; or may be a direct connection, an indirect connection through an intermediate, internal communication between two elements, or an interaction relationship between two elements. The specific meanings of the above terms in the present disclosure may be understood according to specific circumstances for a person of ordinary skill in the art.

In the present disclosure, unless otherwise explicitly stipulated and restricted, that a first feature is “above” or “under” a second feature may include that the first and second features are in direct contact, or may include that the first and second features are not in direct contact but in contact by using other features therebetween. In addition, that the first feature is “on”, “above”, or “over” the second feature includes that the first feature is right above and obliquely above the second feature, or merely indicates that a horizontal height of the first feature is higher than that of the second feature. That the first feature is “below”, “under”, or “beneath” the second feature includes that the first feature is right below and obliquely below the second feature, or merely indicates that a horizontal height of the first feature is lower than that of the second feature.

Many different implementations or examples are provided in the following disclosure to implement different structures of the present disclosure. To simplify the disclosure of the present disclosure, components and settings of specific examples are described below. Certainly, the components and settings are merely examples and are not intended to limit the present disclosure. In addition, in the present disclosure, reference numerals and/or reference letters may be repeated in different examples. The repetition is for the purposes of simplification and clearness, and does not indicate a relationship between various implementations and/or settings discussed. Moreover, the present disclosure provides examples of various specific processes and materials, but a person of ordinary skill in the art may be aware of application of another process and/or use of another material.

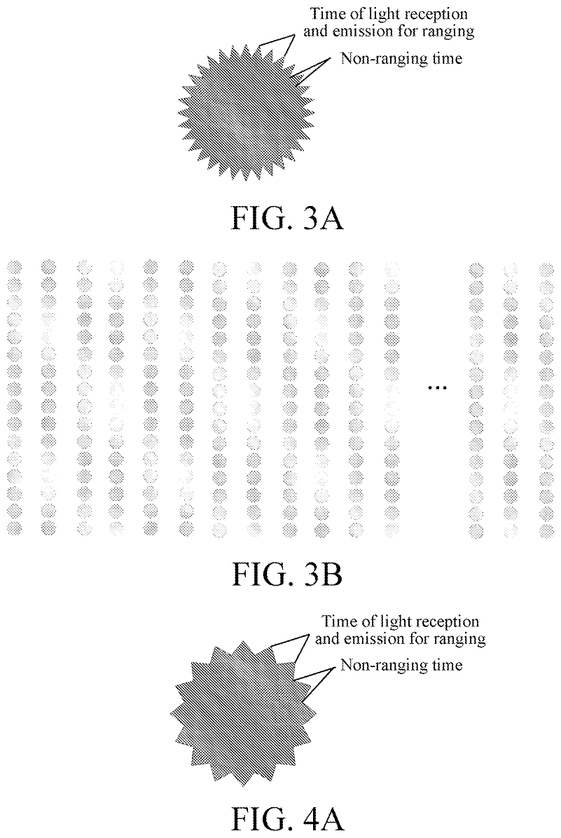

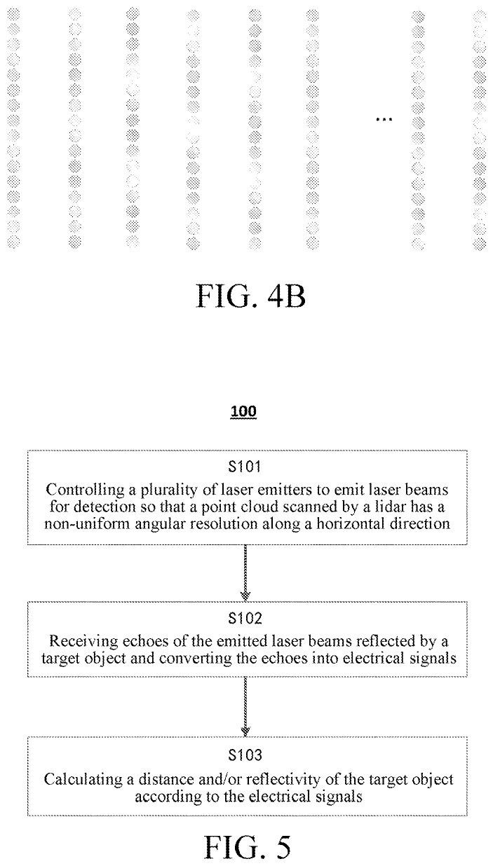

Referring to a lidar in the prior art shown in FIG. 3A, FIG. 3B, FIG. 4A, or FIG. 4B, an angular resolution along a horizontal direction of a mechanical lidar is set fixedly at a factory, and the angular resolution along a horizontal direction of each line is uniform and the same, regardless of working conditions shown in FIG. 3A and FIG. 3B or FIG. 4A and FIG. 4B. In other words, all mechanical lidars on the market at present do not have a function of flexibly configuring the angular resolution along a horizontal direction of certain lines as required.

However, in actual different application scenarios, the mechanical lidar has different requirements for the angular resolution along a horizontal direction at different angles in a field of view or the angular resolution along a horizontal direction of different lines. For example, compared with environmental obstacles inward on a travel side of a vehicle, the lidar used for unmanned driving is more concerned about obstacles in front of the vehicle in a travel direction. If all lines of the mechanical lidar are set to a same angular resolution along a horizontal direction, it will not only increase power consumption of the mechanical lidar, but also make it more difficult to achieve human eye safety, as well as consume more flight time, limit a detection range of the mechanical lidar, and fail to meet customization requirements.

Based on this thinking, an inventor of this application starts to conceive a lidar with a non-uniform angular resolution along a horizontal direction, but a rotation speed of the lidar is extremely fast, it is unreasonable to intermittently control the rotation speed of the lidar in different levels of FOVs (fields of view), and it is also impossible to make certain lines have a different angular resolution along a horizontal direction from that of other lines. After a lot of experiments and theoretical research, the inventor conceived a scheme of this application. On a premise of ensuring that the lidar is capable of rotating around a rotating shaft at a constant speed, by accordingly controlling parameters of emitting laser beams for detection by the plurality of laser emitters, the lidar is enabled to have a non-uniform angular resolution along a horizontal direction, thereby reducing the power consumption of the mechanical lidar, improving the detection range of the mechanical lidar, and meeting more customization requirements.

Exemplary embodiments of the present disclosure are described below in detail with reference to the accompanying drawings. It should be understood that the exemplary embodiments described herein are merely used to describe and explain the present disclosure but are not intended to limit the present disclosure.

FIG. 5 shows a flowchart of a detection method of a lidar according to an embodiment of the present disclosure. The lidar is capable of rotating around a rotating shaft at a constant speed, and includes an emitting unit having a plurality of laser emitters, such as a plurality of laser emitters shown in FIG. 2A or FIG. 2B, which may be arranged either uniformly or non-uniformly. As shown in the figure, a detection method 100 includes the following.

Step S101: Controlling the plurality of laser emitters to emit laser beams for detection so that the lidar has a non-uniform angular resolution along a horizontal direction. Referring to FIG. 6, FIG. 6 shows a schematic diagram of an operation manner of light reception and emission for ranging of a lidar in a horizontal field of view according to an embodiment of the present disclosure. As shown in the figure, the lidar rotates around a rotating shaft (the rotating shaft is in Z direction, which is vertical to a paper surface, and only a point O is visible). A gray sharp angle shown in the figure indicates that at a certain horizontal rotation angle, all channels of the lidar perform light reception and emission for ranging. Meanwhile, a black sharp angle shown in the figure indicates that at another horizontal rotation angle, only part of the channels of the lidar performs light reception and emission for ranging. Therefore, a quantity of channels of light reception and emission for ranging represented by the gray sharp angle is higher than that represented by the black sharp angle. It can be seen that the density of a point cloud scanned by the lidar can be adjusted by controlling the quantity of channels when the lidar emits light at different horizontal angles and/or in the horizontal field of view, and adjusting the angular resolution along a horizontal direction. Through this solution, an expected or an appropriate density of the lidar point cloud can be obtained, so that limited flight time can be used to a maximum extent and power consumption of the lidar can be saved.

Step S102: Receiving echoes of the emitted laser beams for detection reflected by a target object and converting the echoes into electrical signals. The detection laser beam is emitted into an environment around the target object, and is reflected after encountering the target object. A reflected echo is received by the lidar, and an echo signal is converted into an electrical signal for output.

Step S103: Calculating a distance and/or reflectivity between the lidar and the target object according to the electrical signals.

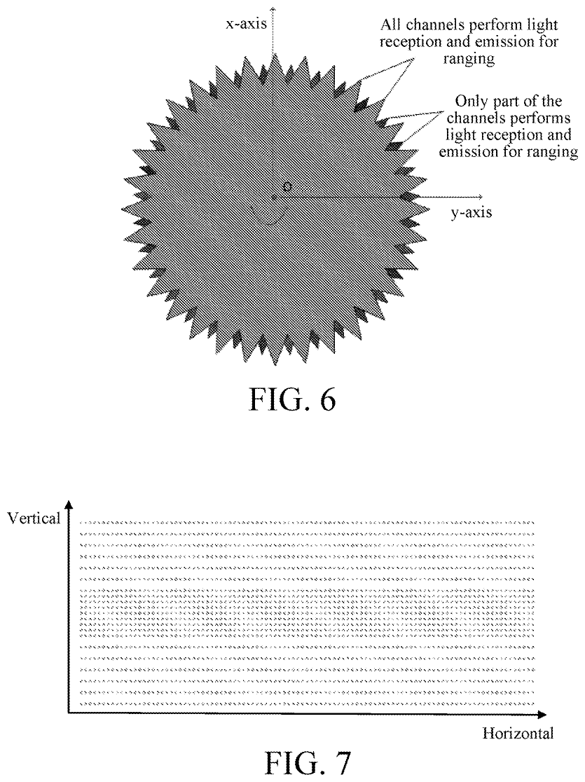

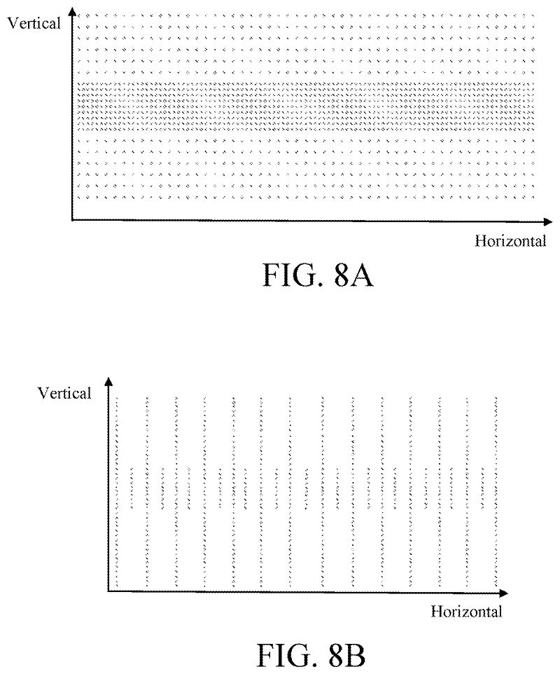

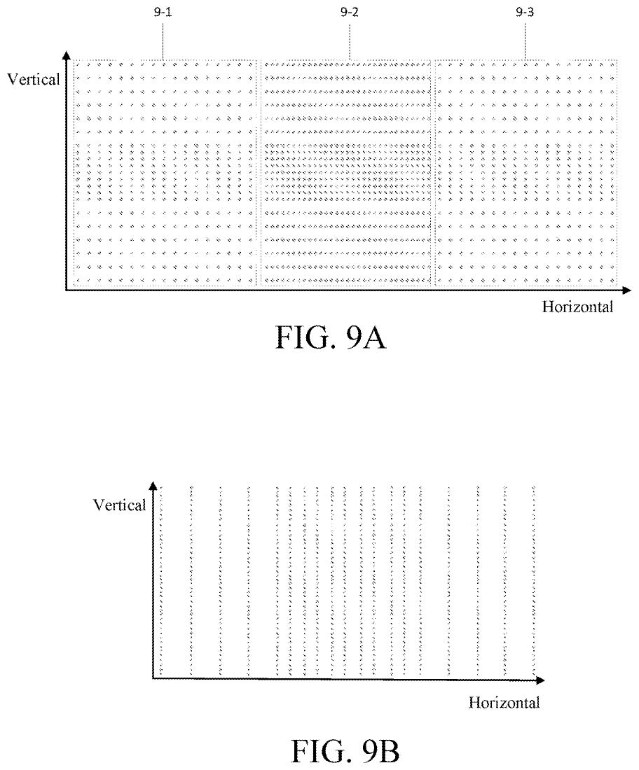

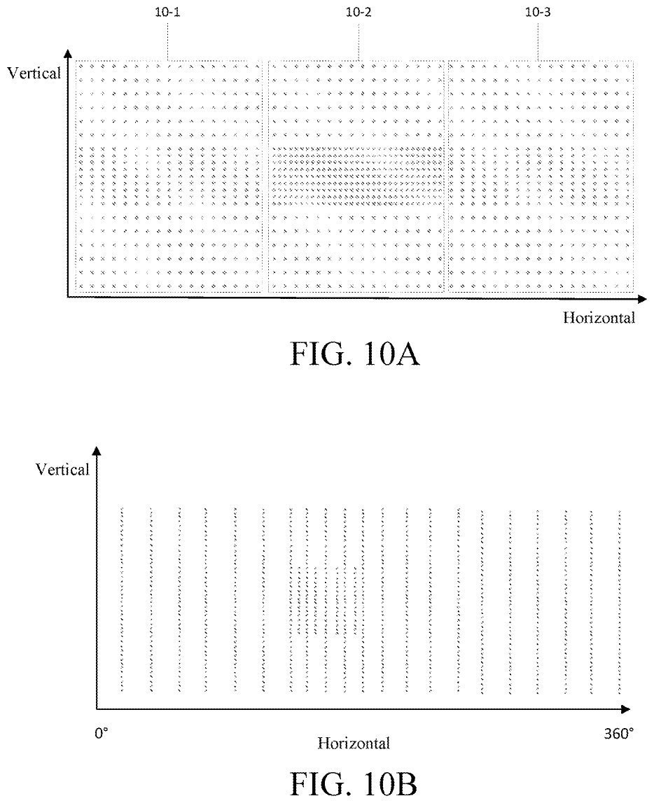

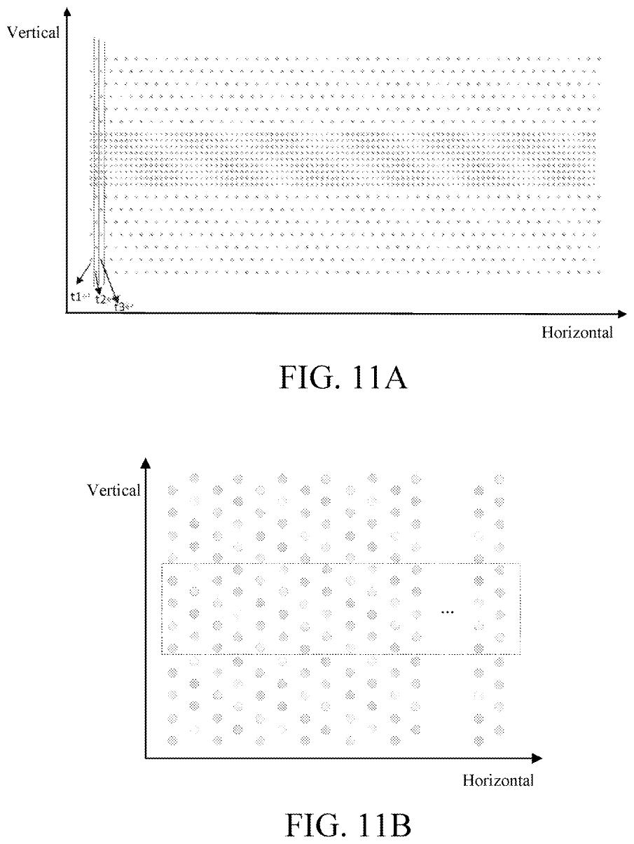

FIG. 7 shows a schematic diagram of a lidar point cloud obtained by using an existing scanning scheme, where the plurality of laser emitters of the lidar are arranged in one or more columns along a direction of the rotating shaft. FIG. 7 shows a point cloud distribution of the lidar in a horizontal direction and a vertical direction (that is, a direction parallel to the rotating shaft). It can be seen from FIG. 7 that the density of the point cloud in several middle columns (center channel) is higher in the vertical direction and the same in the horizontal direction compared with the density of the point cloud in several upper and lower columns (non-center channel). This indicates that an angular resolution along a vertical direction of the central channel of the lidar (composed of a laser emitter adjacent to a middle position and a corresponding detector) is encrypted, and the angular resolution along a horizontal direction is the same everywhere. Therefore, only the angular resolution along a vertical direction is adjusted. Optionally, it can be realized by arranging one or more columns of laser emitters on the lidar closer to the middle position more densely, and arranging laser emitters more adjacent to two sides more sparsely. With reference to the point cloud shown in FIG. 7 and in combination with FIG. 8, FIG. 9, FIG. 10, and FIG. 11, the following further explains how the lidar adjusts the angular resolution along a horizontal direction.

According to an embodiment of the present disclosure, the step S101 includes: controlling the plurality of laser emitters to emit the laser beams for detection at frequencies relatively different from each other. Referring to FIG. 8A and 8B, FIG. 8A and FIG. 8B show partial schematic diagrams of a lidar point cloud according to an embodiment of the present disclosure. The point cloud in the central channel has a higher density in the horizontal direction than that of the point cloud in the non-central channel, which indicates that the laser emitters adjacent to the middle position in the lidar emit laser beams for detection at a higher emission frequency than that of the laser emitters adjacent to the two sides, that is, the angular resolution along a horizontal direction of the central channel is encrypted, thereby realizing the adjustment of the angular resolution along a horizontal direction by the lidar. Compared with the point cloud shown in FIG. 7, in FIG. 8A, the angular resolution along a horizontal direction of the channel at the middle position remains basically the same as that shown in FIG. 7, while the angular resolution along a horizontal direction of the channel at two ends is significantly reduced compared with that shown in FIG. 7, for example, reduced to 50% of that shown in FIG. 7. In the point cloud shown in FIG. 8B, the angular resolution along a horizontal direction of the channel at the middle position is twice that of the channel at the two ends, that is, every time the laser emitters of the channel at the middle position emit the laser beams for detection twice, the laser emitters of the channel at the two ends only emit the laser beams for detection once. Certainly, the emission frequency between the two can also be designed to other proportions according to actual needs.

According to an embodiment of the present disclosure, the step S101 includes: controlling the plurality of laser emitters to emit the laser beams for detection at frequencies relatively different in different horizontal fields of view. Referring to FIG. 9A, FIG. 9A shows a partial schematic diagram of a lidar point cloud according to an embodiment of the present disclosure. Different from FIG. 8, a point cloud distribution in the horizontal direction in FIG. 9A is non-uniform. A horizontal field of view is divided into three regions, namely 9-1, 9-2, and 9-3 from left to right. The middle region 9-2 has a higher point cloud density in the horizontal direction than that of the regions 9-1 and 9-3 on two sides. This indicates that the lidar emits laser beams for detection with different frequencies in different regions in the horizontal field of view, thereby realizing the adjustment of the angular resolution along a horizontal direction by the lidar. Optionally, in FIG. 9A, the point cloud in the central channel has a higher density in the vertical direction than that of the point cloud in the non-central channel. Therefore, while the angular resolution along a horizontal direction of the lidar is adjusted, the angular resolution along a vertical direction of the lidar can also be adjusted.

FIG. 9B shows a partial schematic diagram of a lidar point cloud according to another embodiment of the present disclosure. As shown in FIG. 9B, a plurality of channels or all channels of the lidar have different angular resolution along a horizontal direction in the horizontal field of view. At the middle position of the horizontal field of view in FIG. 9B, the angular resolution along a horizontal direction of each channel is significantly higher than that at a peripheral part of the horizontal field of view.

FIG. 10A shows a partial schematic diagram of a lidar point cloud according to an embodiment of the present disclosure. Similar to FIG. 9A, the horizontal field of view in FIG. 10A is also divided into three regions 10-1, 10-2 and 10-3 from left to right. Different from FIG. 9A, a point cloud density of the region 10-2 on the central channel is higher than that of the regions 10-1 and 10-3 on the two sides in the horizontal direction, and the point cloud density of the three regions on the non-central channel is the same. That is, by encrypting part of horizontal angle regions of the central channel, the angular resolution along a horizontal direction of the lidar is adjusted. A person of ordinary skill in the art can understand that in at least a subsection of the horizontal fields of view, the laser emitters located adjacent to a central part of a vertical field of view in the one or more columns of the lidar may be controlled as required to emit the laser beams for detection at a frequency higher than that of the laser emitters located adjacent to a peripheral part of the vertical field of view, to obtain a non-uniform angular resolution along a horizontal direction.

FIG. 10B shows a partial schematic diagram of a lidar point cloud according to another embodiment of the present disclosure, which is similar to FIG. 9B. However, different from FIG. 9B, in FIG. 10B, at the middle position of the horizontal field of view, the laser emitters of the lidar located adjacent to a center position of the vertical field of view emit the laser beams for detection at a frequency higher than that of the laser emitters located adjacent to a peripheral part of the vertical field of view.

According to an embodiment of the present disclosure, the step S101 includes: controlling the plurality of laser emitters and selecting at least partially different laser emitters to emit the laser beams for detection at different horizontal angles. Referring to FIG. 11A, FIG. 11A shows a partial schematic diagram of a lidar point cloud according to an embodiment of the present disclosure. It can be seen from FIG. 11A that the point cloud is arranged in a staggered manner in the vertical direction. Taking the lidar with a total quantity of X receiving and emitting channels as an example, at time t1, a corresponding horizontal angle of the lidar is α1, and at this time, a receiving and emitting channel 1 to a channel X1 is controlled to perform light reception and emission for ranging; at time t2, the corresponding horizontal angle of the lidar is α2, and at this time, the receiving and emitting channel 1+X1 to a channel X is controlled to perform light reception and emission for ranging; and at time t3, the corresponding horizontal angle of the lidar is α3, and at this time, the receiving and emitting channel 1 to the channel X1 is controlled to perform light reception and emission for ranging (where the X1 is less than the X). Repeat like this, part of the receiving and emitting channels in the total receiving and emitting channels performs light reception and emission for ranging in a staggered manner. According to another embodiment of the present disclosure, at the time t1, the corresponding horizontal angle is α1, and at this time, the receiving and emitting channel 1 to the channel X1 is controlled to perform light reception and emission for ranging; at the time t2, the corresponding horizontal angle is α2, and at this time, the receiving and emitting channel 1+X1 to a channel X2 is controlled to perform light reception and emission for ranging; and at the time t3, the corresponding horizontal angle is α3, and at this time, a receiving and emitting channel 1+X2 to the channel X is controlled to perform light reception and emission for ranging, where the X1 is less than the X2, and the X2 is less than the X. That is, a plurality of different horizontal fields of view can be selected as needed, and a plurality of different receiving and emitting channels can be controlled to perform light reception and emission for ranging in the horizontal fields of view, so that the lidar is capable of obtaining different angular resolutions along a horizontal direction.

In FIG. 11A, the lidar has a non-uniform resolution in the vertical field of view. FIG. 11B shows a partial schematic diagram of a lidar point cloud with a uniform resolution in a vertical field of view.

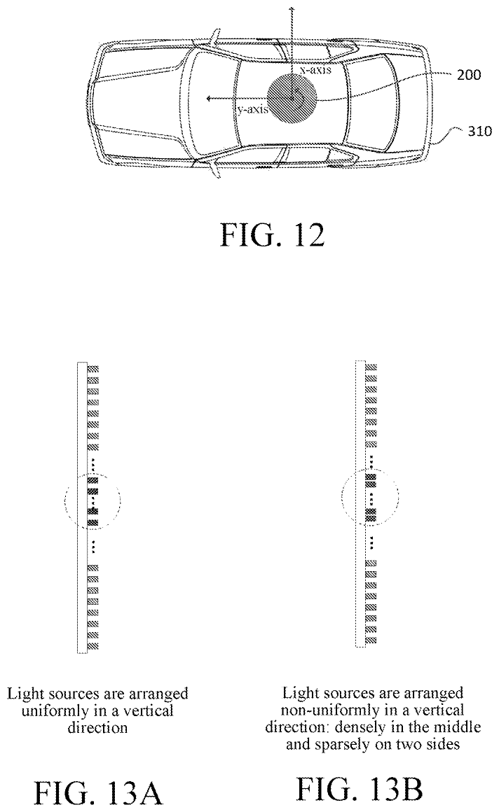

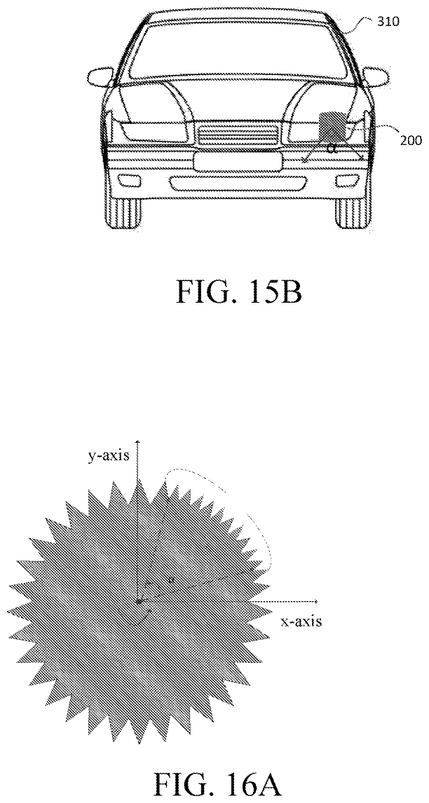

FIG. 12 and FIG. 15A respectively show schematic diagrams of a vehicle equipped with a lidar according to an embodiment of the present disclosure. The step S101 includes: controlling the plurality of laser emitters to emit the laser beams for detection in a predetermined field of view that is located in front of a vehicle and along a travel direction of the vehicle at a higher frequency than that outside the predetermined field of view, wherein the vehicle is equipped with the lidar. Detailed description is provided below with reference to FIG. 12 to FIG. 16.

As shown in FIG. 12, the lidar is installed on a roof of the vehicle and is capable of rotating around a rotating shaft. When the vehicle moves forward, a main field of view thereof corresponds to a detection range of the lidar close to a central channel. In this case, an angular resolution along a horizontal direction of the central channel is more important than that of non-central channels on two sides. Therefore, laser emitters located adjacent to a central part are controlled to emit laser beams for detection at a frequency higher than that of laser emitters located adjacent to positions on two sides, so that the vehicle gets a denser point cloud in a main field of view during forward driving, thereby obtaining more detection information. Optionally, the lidar has 128 channels or lines, channel 26 to channel 89 are set as horizontal encrypted channels, light reception and emission for ranging is performed at intervals of 0.1°, and other channels are set to perform light reception and emission for ranging at intervals of

FIG. 13A and FIG. 13B show schematic diagrams of arrangement of laser emitters according to an embodiment of the present disclosure. The laser emitters are arranged in one or more columns along a direction of the rotating shaft of the lidar. FIG. 13A and FIG. 13B schematically show arrangement of one column of laser emitters. As shown in FIG. 13A, the laser emitters are arranged uniformly in a vertical direction. As shown in FIG. 13B, the laser emitters are arranged non-uniformly in the vertical direction, and in particular, arranged densely in the middle and sparsely on two sides. Optionally, the lidar in FIG. 12 adopts an arrangement manner of the laser emitters shown in FIG. 13B, and encrypts the angular resolution along a horizontal direction of the central channel, so that the angular resolution along a horizontal direction and an angular resolution along a vertical direction can be adjusted simultaneously. A person of ordinary skill in the art can understand that, for an actual lidar, a plurality of columns of light sources as shown in FIG. 13A and FIG. 13B may be set, and in each column, types of the light sources may be the same or different, where the light source is optionally the laser emitter of the present disclosure. According to an embodiment of the present disclosure, all the light source columns in the lidar may be set to uniform arrangement as shown in FIG. 13A (the point cloud maps are shown in, for example, FIG. 8B, FIG. 9B, FIG. 10B, and FIG. 11B), or set to non-uniform arrangement as shown in FIG. 13B (the point cloud maps are shown in, for example, FIG. 8A, FIG. 9A, FIG. 10A, and FIG. 11A). Alternatively, part of the light source columns may be set to uniform arrangement as shown in FIG. 13A, and the rest may be set to non-uniform arrangement as shown in FIG. 13B. A specific quantity of light source columns may be set according to actual needs. According to another embodiment of the present disclosure, an arrangement relationship of a plurality of light source columns may also be different, for example, part of the light source columns is vertically arranged, and the rest are aligned side by side, or staggered side by side, so as to achieve different detection requirements for different application scenarios.

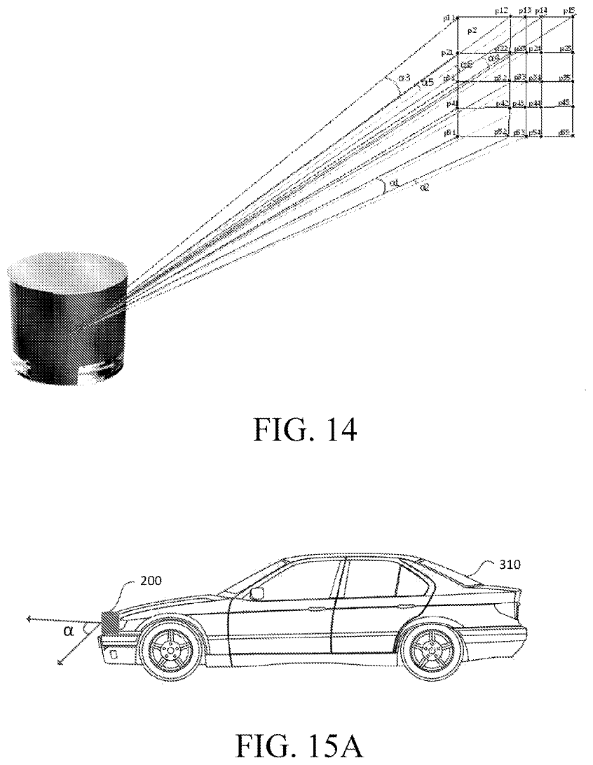

FIG. 14 shows a partial schematic diagram of scanning a point cloud according to an embodiment of the present disclosure. As shown in the figure, a rotation speed of the lidar is fixed, and four scanning lines shown in the figure are relatively uniformly arranged, where α1>α2, a rotation angle α1 corresponds to the lidar scanning from a point P51 to a point P52 on the point cloud, and a rotation angle α2 corresponds to the lidar scanning from the point P52 to a point P53 on the point cloud. Similarly, a rotation angle α3 corresponds to the lidar scanning from a point P11 to a point P12 on the point cloud, and by analogy to α4, α5, and α6. Taking P1X as an example, α3 (P11→P12)=α4 (P14→P15)>α5 (P12→P13)=α6 (P13→P14), and thus it can be seen that an angular resolution along a horizontal direction in a range of a field of view α1 is lower than that in a range of a field of view α2.

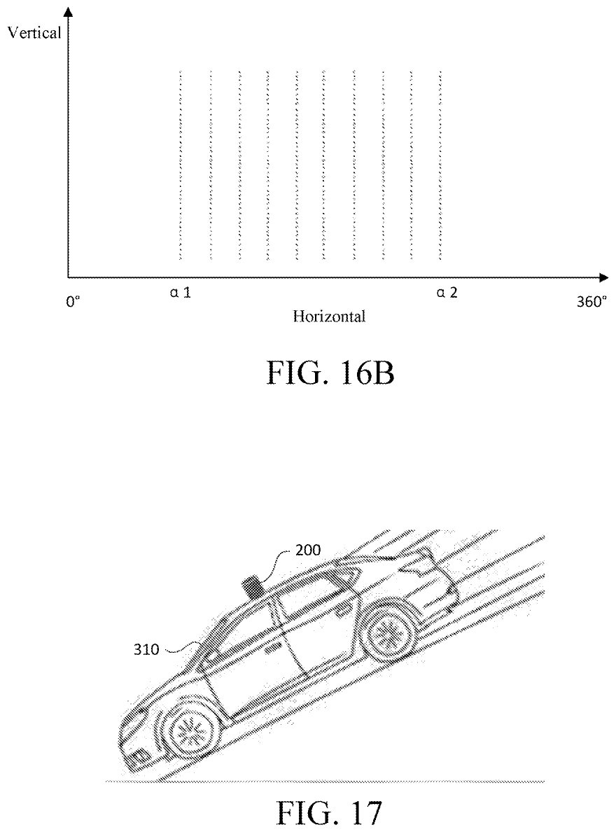

As shown in FIG. 15A and FIG. 15B, the lidar is installed at the front of the vehicle, such as a lamp, and rotates around a rotating shaft. FIG. 15A and FIG. 15B respectively show a side view and a front view of the vehicle. As shown in the figures, the lidar is configured for blind compensation of a lidar, and its main field of view is a field of view with a horizontal angle range of α in a forward direction of the vehicle, corresponding to a detection range of the lidar in the field of view α. Referring to FIG. 16A and FIG. 16B, FIG. 16A shows a schematic diagram of light reception and emission for ranging of the lidars shown in FIG. 15A and FIG. 15B within a horizontal angle range, and FIG. 16B shows a point cloud map of the lidar. In this case, a plurality of receiving and emitting channels of the lidar are set to emit laser beams for detection in the field of view α with a frequency of a field of view higher than the field of view α, or the receiving and emitting channels are closed outside the field of view α, so that a denser point cloud can be obtained in the horizontal angle range of α when the vehicle drives forward, thereby obtaining more detection information. As shown in FIG. 16B, α2−α1=α. In a horizontal field of view from α1 to α2, the receiving and emitting channels of the lidar emit the laser beams for detection normally, or emit the laser beams for detection at a higher frequency. In horizontal field of views from 0° to α1 and from α2 to 360°, the receiving and emitting channels of the lidar is capable of stopping emitting light, or alternatively, detect light emission at a lower frequency.

According to an embodiment of the present disclosure, the plurality of laser emitters are arranged in one or more columns along the direction of the rotating shaft, and the detection method further includes: receiving scene information. The step S101 further includes: determining an expected angular resolution along a horizontal direction for a lidar point cloud according to the scene information and adjusting light emission frequency of the laser emitter. Determination of the scene information may be implemented by other sensors such as cameras. Specifically, the lidar is used together with the camera, and the camera is used for image acquisition and image recognition to provide some scene information for the lidar to determine. Alternatively, the point cloud may be obtained only by the lidar, and the existing environment and scene information of the vehicle may be determined through point cloud information.

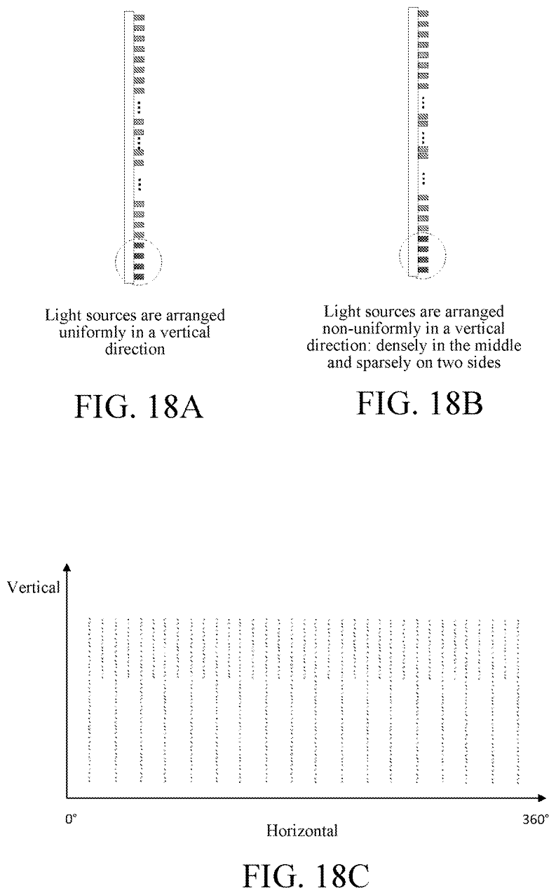

FIG. 17 shows a schematic diagram of a vehicle equipped with a lidar in a downhill state according to an embodiment of the present disclosure. Optionally, FIG. 18A and FIG. 18B show schematic diagrams of arrangement of laser emitters of the lidar shown in FIG. 17, where FIG. 18A shows a case that the laser emitters are arranged uniformly in the vertical direction, and FIG. 18B shows a case that the laser emitters are arranged non-uniformly in the vertical direction. As shown in FIG. 17, the lidar is installed on a roof of the vehicle and rotates around a rotating shaft thereof. When it is detected or received that the vehicle equipped with the lidar is traveling in the downhill state, at this time, its main field of view is an angle range vertical to the rotating shaft and inclined to the sky, corresponding to a detection range of the lidar adjacent to a lower channel position. In this case, no matter the arrangement in FIG. 18A or FIG. 18B, by controlling laser emitters adjacent to a lower side (such as a lower part) in at least one column of laser emitters to emit laser beams for detection at a higher frequency than that of laser emitters adjacent to an upper side (such as an upper part), the lidar is capable of obtaining a denser point cloud in a field of view close to the above sky, thereby obtaining more detection information. FIG. 18C shows a partial schematic diagram of a point cloud in a case that the laser emitters are arranged as shown in FIG. 18A.

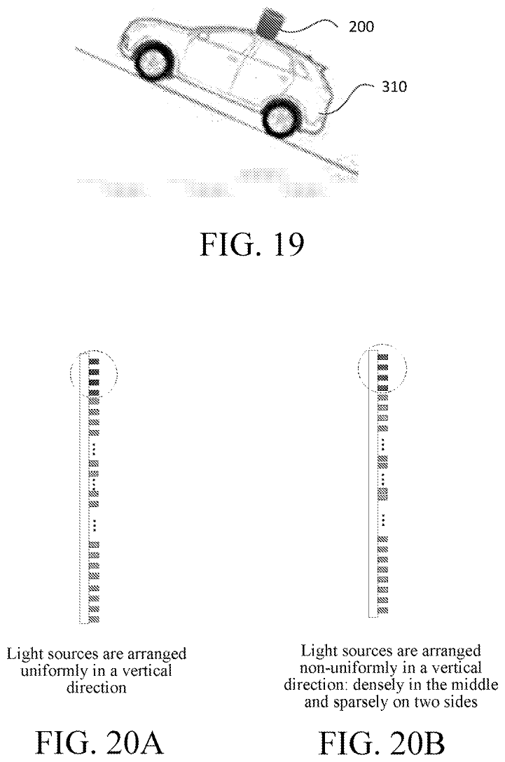

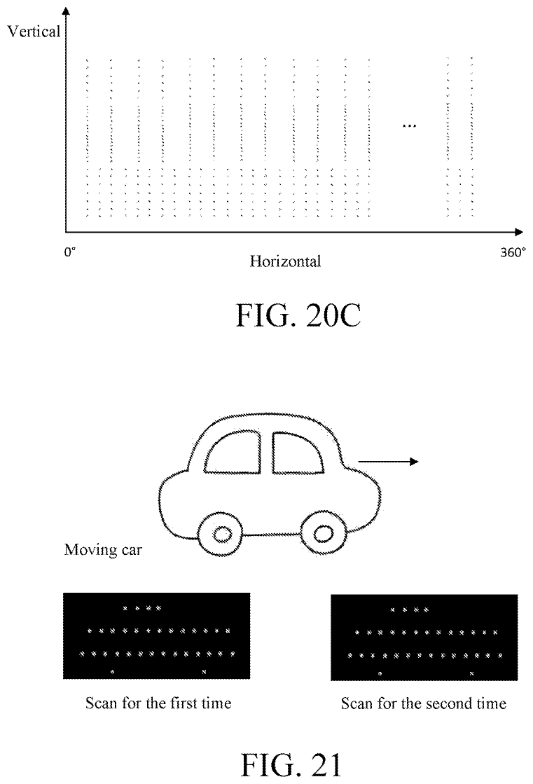

FIG. 19 shows a schematic diagram of a vehicle equipped with a lidar in an uphill state according to an embodiment of the present disclosure. Optionally, FIG. 20A and FIG. 20B show schematic diagrams of arrangement of laser emitters of the lidar shown in FIG. 19, where FIG. 20A shows a case that the laser emitters are arranged uniformly in the vertical direction, and FIG. 20B shows a case that the laser emitters are arranged non-uniformly in the vertical direction. As shown in FIG. 19, the lidar is installed on a roof of the vehicle and rotates around a rotating shaft thereof. When it is detected or received that the vehicle equipped with the lidar is traveling in the uphill state, at this time, its main field of view is an angle range vertical to the rotating shaft and inclined to the ground, corresponding to a detection range of the lidar adjacent to an upper channel position. In this case, no matter the arrangement of FIG. 20A or FIG. 20B, by controlling laser emitters adjacent to an upper side (such as an upper part) in at least one column of laser emitters to emit laser beams for detection at a higher frequency than that of laser emitters adjacent to a lower side (such as a lower part), the lidar is capable of obtaining a denser point cloud in a field of view close to the below ground, thereby obtaining more detection information. FIG. 20C shows a partial schematic diagram of a point cloud in a case that the laser emitters are arranged as shown in FIG. 20B.

According to an embodiment of the present disclosure, when a preset obstacle is detected, depending on the type and location of the obstacle, the laser emitter is controlled to emit the laser beams for a next detection at a frequency different from that of a previous detection of the obstacle. A processing unit of the lidar is capable of processing and identifying the point cloud. Optionally, a point cloud processing unit outside the lidar is capable of processing and identifying the point cloud to identify the type of the obstacle. When the type of the preset obstacle is detected, according to the type and the position of the obstacle, when the lidar rotates to a horizontal angle corresponding to the obstacle again, the lidar is capable of detecting the same obstacle at a frequency different from that of the previous detection. For example, as shown in FIG. 21, according to the point cloud scanned by the lidar for the first time, the obstacle is determined as a vehicle. According to the point cloud of the lidar, a travel direction and a relative speed of the vehicle can be determined. At the same time, combined with a rotation speed of the lidar, time to scan the vehicle for the next detection or a corresponding horizontal field of view angle can be predicted. Correspondingly, when the lidar scans the horizontal field of view angle for the second time, a detection frequency can be adjusted.

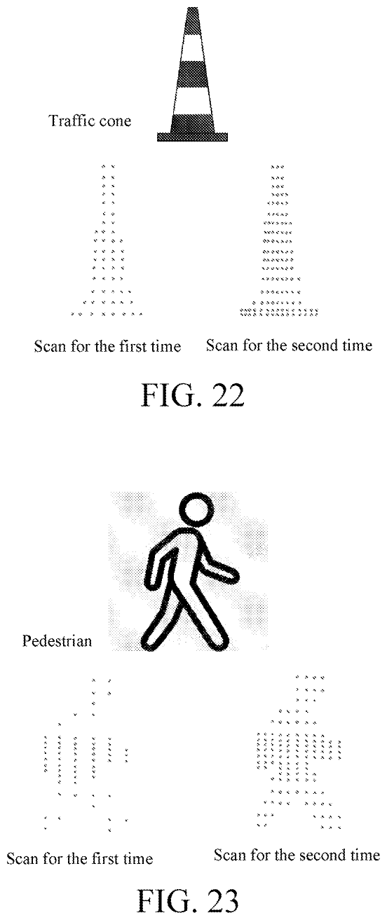

In autonomous driving scenarios, pedestrians and traffic cones are objects that an autonomous driving system needs to pay special attention to, that is, traffic sensitive objects, which are objects that affect a decision of a driver to slow down or stop. FIG. 22 and FIG. 23 respectively show schematic diagrams of a case that a lidar scans a traffic cone or a pedestrian. According to the present disclosure, when a pedestrian or a traffic cone is detected, the laser emitter is controlled to emit the laser beams at a higher frequency for the next detection of the obstacle.

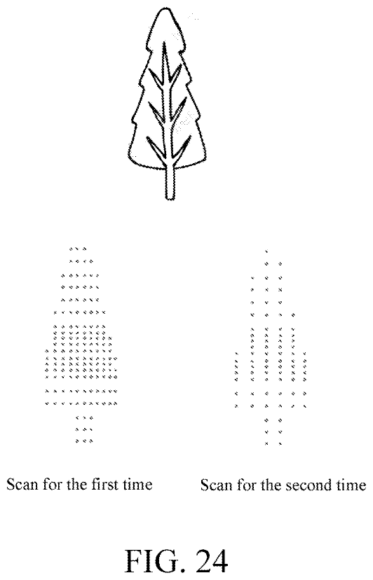

When some static objects on two sides of a road, such as trees, are scanned, the lidar is capable of emitting the laser beams at a lower frequency in the next detection, as shown in FIG. 24.

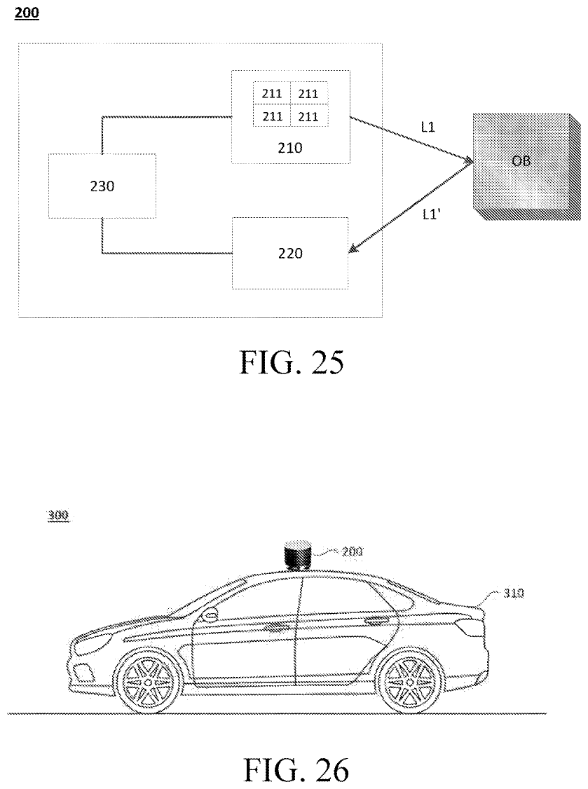

The present disclosure further relates to a lidar, for example, FIG. 25 shows a block diagram of a lidar according to an embodiment of the present disclosure. A lidar 200 is capable of rotating around a rotating shaft, and includes: an emitting unit 210, a receiving unit 220, and a control unit 230. The emitting unit 210 includes a plurality of laser emitters 211, and the plurality of laser emitters 211 are configured to emit laser beams for detection L1 for detecting a target object OB. The receiving unit 220 is configured to receive echoes L1′ of the laser beams for detection L1 reflected by the target object OB and convert the echoes into electrical signals. The control unit 230 is coupled to the emitting unit 210, and is configured to control the plurality of laser emitters 211 to emit the laser beams for detection L1 so that the lidar 200 has a non-uniform angular resolution along a horizontal direction.

According to an embodiment of the present disclosure, the control unit 230 is configured to: control the plurality of laser emitters 211 to emit the laser beams for detection L1 at frequencies relatively different from each other. Referring to FIG. 8A, the laser emitters adjacent to a central part of the lidar are controlled to emit the laser beams for detection at an emission frequency higher than that of the laser emitters adjacent to two sides, so that the point cloud density of the central channel is higher than that of the non-central channel, and encryption of the angular resolution along a horizontal direction of the central channel is realized.

According to an embodiment of the present disclosure, the control unit 230 is configured to: control the plurality of laser emitters 211 to emit the laser beams for detection L1 at frequencies relatively different in different horizontal fields of view. Referring to FIG. 9A, the plurality of laser emitters 211 of the lidar are controlled to emit the laser beams for detection with different frequencies in different regions (9-1, 9-2, 9-3) in the horizontal field of view to obtain the point cloud with different densities, thereby realizing the adjustment of the angular resolution along a horizontal direction by the lidar.

According to an embodiment of the present disclosure, the control unit 230 is configured to: control the plurality of laser emitters 211 and select at least partially different laser emitters to emit the laser beams for detection L1 at different horizontal angles. Referring to FIG. 11A, the lidar with a total quantity of X receiving and emitting channels has the horizontal angles α1, α2, and α3 corresponding to different times t1, t2 and t3. The light reception and emission for ranging is performed from the receiving and emitting channel 1 to the channel X1, from the channel 1+X1 to the channel X, and from the channel 1 to the channel X1 (where the X1 is less than the X) in the lidar to obtain staggered point clouds, so as to realize the adjustment of the angular resolution along a horizontal direction of the lidar.

According to an embodiment of the present disclosure, as shown in FIG. 13A and FIG. 13B, the plurality of laser emitters 211 are arranged in one or more columns along the direction of the rotating shaft, and the control unit 230 is configured to: control, in at least a subsection of the horizontal fields of view, laser emitters located adjacent to a central part of vertical fields of view in the one or more columns to emit the laser beams for detection L1 at a frequency higher than that of laser emitters located adjacent to a peripheral part of the vertical fields of view, as shown in FIG. 11A and FIG. 11B.

According to an embodiment of the present disclosure, as shown in FIG. 16A, the control unit 230 is configured to: control the plurality of laser emitters 211 to emit the laser beams for detection L1 in a predetermined field of view α in front of a vehicle equipped with the lidar 200 in a travel direction at a higher frequency than that outside the predetermined field of view α, to obtain more detection information in the predetermined field of view α.

According to an embodiment of the present disclosure, the plurality of laser emitters 211 are arranged in one or more columns along the direction of the rotating shaft, and the control unit 230 is configured to determine an expected angular resolution along a horizontal direction for a lidar point cloud according to received scene information and adjust light emission of the laser emitter 211. The scene information includes that the vehicle equipped with the lidar is in a downhill state and an uphill state. The adjustment of the laser emitters in different scenarios is further described in combination with FIG. 17, FIG. 18, FIG. 19, and FIG. 20.

According to an embodiment of the present disclosure, as shown in FIG. 17, FIG. 18A, FIG. 18B, and FIG. 18C, the control unit 230 is configured to: when it is detected or received that the vehicle equipped with the lidar 200 is in a downhill state, control laser emitters located adjacent to a lower side in at least one column of laser emitters to emit the laser beams for detection L1 at a higher frequency than that of laser emitters located adjacent to an upper side, so that the downhill vehicle is capable of obtaining a denser point cloud in a field of view at a vertical angle of more interest, which is inclined to the sky.

According to an embodiment of the present disclosure, as shown in FIG. 19, FIG. 20A, FIG. 20B, and FIG. 20C, the control unit 230 is configured to: when it is detected or received that the vehicle equipped with the lidar 200 is in an uphill state, control laser emitters located adjacent to an upper side in at least one column of laser emitters to emit the laser beams for detection L1 at a higher frequency than that of laser emitters located adjacent to a lower side, so that the uphill vehicle is capable of obtaining a denser point cloud in a field of view at a vertical angle of more interest, which is inclined to the ground.

According to an embodiment of the present disclosure, as shown in FIG. 13B, in at least one column of laser emitters, the laser emitters adjacent to a central part of a vertical field of view are arranged with a density higher than that of the laser emitters adjacent to a peripheral part of the vertical field of view.

According to an embodiment of the present disclosure, the control unit is adapted to: when a preset obstacle is detected, depending on the type and location of the obstacle, control the laser emitter to emit the laser beams for a next detection at a frequency different from that of a previous detection of the obstacle.

According to an embodiment of the present disclosure, the control unit is adapted to: when a pedestrian or a traffic cone is detected, control the laser emitter to emit the laser beams at a higher frequency for the next detection of the obstacle, as shown in FIG. 22 and FIG. 23.

According to an embodiment of the present disclosure, the control unit is adapted to: when a tree is detected, control the laser emitter to emit the laser beams at a lower frequency for a next detection of the obstacle, as shown in FIG. 24.

The present disclosure further relates to a system for a vehicle. For example, FIG. 26 shows a schematic diagram of a system for a vehicle according to an embodiment of the present disclosure. The system for a vehicle 300 includes: a vehicle body 310 and the lidar 200. The lidar 200 is installed on the vehicle body 310, so as to detect a target object around the vehicle body 310.

According to an embodiment of the present disclosure, as shown in FIG. 15A, the lidar 200 is installed at the front of the vehicle body 310, and a control unit of the lidar 200 is configured to: control the plurality of laser emitters to emit the laser beams for detection in a predetermined field of view α in front of a vehicle equipped with the lidar 200 in a travel direction at a higher frequency than that outside the predetermined field of view α.

According to an embodiment of the present disclosure, as shown in FIG. 12, the lidar 200 is installed on a roof of the vehicle body 310, and the plurality of laser emitters are arranged in one or more columns along the direction of the rotating shaft. The system for a vehicle 300 further includes a photographing unit (not shown), the photographing unit is capable of collecting images around the vehicle and determine scene information according to the images, and the control unit of the lidar 200 communicates with the photographing unit to receive the scene information and is configured to determine an expected angular resolution along a horizontal direction for a lidar point cloud according to the scene information and adjust light emission frequency of the laser emitter. The scene information, for example, may include: the vehicle being in a downhill state or an uphill state. When the vehicle is in the downhill state, as shown in FIG. 17, laser emitters located adjacent to a lower side in at least one column of laser emitters of the lidar 200 are controlled to emit the laser beams for detection at a higher frequency than that of laser emitters located adjacent to an upper side; and when the vehicle is in the uphill state, as shown in FIG. 19, laser emitters located adjacent to an upper side in at least one column of laser emitters of the lidar 200 are controlled to emit the laser beams for detection at a higher frequency than that of laser emitters located adjacent to a lower side, and adjust an angular resolution along a horizontal direction of the lidar 200.

An embodiment of the present disclosure provides a method for adjusting an angular resolution along a horizontal direction. According to different needs for actual application scenarios, different channels or lines of the lidar are controlled to perform light reception and emission for ranging according to different frequencies, so that the lidar has a non-uniform angular resolution along a horizontal direction, thereby implementing the adjustment of the angular resolution along a horizontal direction of the lidar.

Finally, it should be noted that: the foregoing descriptions are merely exemplary embodiments of the present disclosure, but are not intended to limit the present disclosure. Although the present disclosure has been described in detail with reference to the foregoing embodiments, for a person of ordinary skill in the art, modifications can be made to the technical solutions described in the foregoing embodiments, or equivalent replacements can be made to some technical features in the technical solutions. A person skilled in the art may make various modifications and changes to the present disclosure. Any modification, equivalent replacement, or improvement made without departing from the spirit and principle of the present disclosure shall fall within the protection scope of the present disclosure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A detection method of a lidar capable of rotating around a rotating shaft at a constant speed and comprising an emitting unit having a plurality of laser emitters, the detection method comprising:
S101: controlling the plurality of laser emitters to emit laser beams for detection so that the lidar has a non-uniform angular resolution along a horizonal direction;
S102: receiving echoes of the emitted laser beams for detection reflected by a target object and converting the echoes into electrical signals; and
S103: calculating a distance and/or reflectivity of the target object according to the electrical signals.

2. The detection method according to claim 1, wherein the step S101 comprises:
controlling the plurality of laser emitters to emit the laser beams for detection at frequencies relatively different from each other; and/or
controlling the plurality of laser emitters to emit the laser beams for detection at frequencies relatively different in different horizontal fields of view; and/or
controlling the plurality of laser emitters and selecting at least partially different laser emitters to emit the laser beams for detection at different horizontal angles.

3. The detection method according to claim 1, wherein the plurality of laser emitters are arranged in one or more columns along a direction of the rotating shaft, and the step S101 comprises: controlling, in at least a subsection of the horizontal fields of view, laser emitters located adjacent to a central part of vertical fields of view in the one or more columns to emit the laser beams for detection at a frequency higher than that of laser emitters located adjacent to a peripheral part of the vertical fields of view.

4. The detection method according to claim 1, wherein the step S101 comprises: controlling the plurality of laser emitters to emit the laser beams for detection in a predetermined field of view that is located in front of a vehicle and along a travel direction of the vehicle at a higher frequency than that outside the predetermined field of view, wherein the vehicle is equipped with the lidar.

5. The detection method according to claim 1, wherein the plurality of laser emitters are arranged in one or more columns along the direction of the rotating shaft, and the detection method further comprises:
receiving scene information,
wherein the step S101 further comprises: determining an expected angular resolution along a horizontal direction for a lidar point cloud according to the scene information and adjusting light emission frequency of the laser emitter.

6. The detection method according to claim 5, wherein the step S101 comprises: when it is detected or received that the vehicle equipped with the lidar is in a downhill state, controlling laser emitters located relatively close to a lower side in at least one column of laser emitters to emit the laser beams for detection at a higher frequency than that of laser emitters located adjacent to an upper side.

7. The detection method according to claim 5, wherein the step S101 comprises: when it is detected or received that the vehicle equipped with the lidar is in an uphill state, controlling laser emitters located adjacent to an upper side in at least one column of laser emitters to emit the laser beams for detection at a higher frequency than that of laser emitters located adjacent to a lower side.

8. The detection method according to claim 5, wherein the step S101 comprises: when a preset obstacle is detected, depending on the type and movement speed of the obstacle, controlling the laser emitter to emit the laser beams for a next detection at a frequency different from that of a previous detection of the obstacle.

9. The detection method according to claim 8, wherein the step S101 comprises: when a traffic sensitive object is detected, controlling the laser emitter to emit the laser beams for the next detection at a higher frequency when the laser emitter scans the obstacle again, the traffic sensitive object comprising pedestrians or traffic cones; and/or
when a non-sensitive object is detected, controlling the laser emitter to emit the laser beams for the next detection at a lower frequency when the laser emitter scans the obstacle again, the non-sensitive object comprising trees.

10. A lidar capable of rotating around a rotating shaft at a constant speed comprising:
an emitting unit, comprising a plurality of laser emitters, the plurality of laser emitters being configured to emit laser beams for detecting a target object;
a receiving unit, configured to receive echoes of the emitted laser beams for detection reflected by the target object and convert the echoes into electrical signals; and
a control unit, coupled to the emitting unit, and configured to control the plurality of laser emitters to emit the laser beams for detection so that the lidar has a non-uniform angular resolution along a horizontal direction.

11. The lidar according to claim 10, wherein the control unit is configured to: control the plurality of laser emitters to emit the laser beams for detection at frequencies relatively different from each other; and/or
control the plurality of laser emitters to emit the laser beams for detection at frequencies relatively different in different horizontal fields of view; and/or
control the plurality of laser emitters and select at least partially different laser emitters to emit the laser beams for detection at different horizontal angles.

12. The lidar according to claim 10, wherein the plurality of laser emitters are arranged in one or more columns along a direction of the rotating shaft, and the control unit is configured to: control, in at least a subsection of the horizontal fields of view, laser emitters located relatively adjacent to a central part of vertical fields of view in the one or more columns to emit the laser beams at a frequency higher than that of laser emitters located relatively adjacent to a peripheral part of the vertical fields of view.

13. The lidar according to claim 10, wherein the control unit is configured to: control the plurality of laser emitters to emit the detection laser beams in a predetermined field of view that is located in front of a vehicle and along a travel direction of the vehicle at a higher frequency than that outside the predetermined field of view, wherein the vehicle is equipped with the lidar.

14. The lidar according to claim 10, wherein the plurality of laser emitters are arranged in one or more columns along the direction of the rotating shaft, and the control unit is configured to determine an expected angular resolution along a horizontal direction for a lidar point cloud according to received scene information and adjust light emission of the laser emitter.

15. The lidar according to claim 10, wherein the control unit is adapted to: when a preset obstacle is detected, depending on the type and location of the obstacle, control the laser emitter to emit the laser beams for a next detection of the preset obstacle at a frequency different from that of a previous detection of the obstacle.

16. The lidar according to claim 15, wherein the control unit is adapted to: when a pedestrian or a traffic cone is detected, control the laser emitter to emit the laser beams at a higher frequency for the next detection of the obstacle.

17. The lidar according to claim 15, wherein the control unit is adapted to: when a tree is detected, control the laser emitter to emit the detection laser beams at a lower frequency for a next detection of the obstacle.

18. A system for a vehicle, comprising:
a vehicle body; and
the lidar according to claim 10, the lidar being installed on the vehicle body, so as to detect a target object around the vehicle body.

19. The system according to claim 18, wherein the lidar is installed at the front of the vehicle body, and a control unit of the lidar is configured to: control the plurality of laser emitters to emit the laser beams for detection in a predetermined field of view that is located in front of the vehicle and along a travel direction of the vehicle at a higher frequency than that outside the predetermined field of view, wherein the vehicle is equipped with the lidar.

20. The system according to claim 18, wherein the lidar is installed on a roof of the vehicle body, the plurality of laser emitters are arranged in one or more columns along the direction of the rotating shaft, the system further comprises a photographing unit, the photographing unit is capable of collecting images around the vehicle and determine scene information according to the images, and the control unit of the lidar communicates with the photographing unit to receive the scene information and is configured to determine an expected angular resolution along a horizontal direction for a lidar point cloud according to the scene information and adjust light emission frequency of the laser emitter.
